(19) United States
(12) Patent Application Publication
(10) Pub. No.: US 2015/0204459 A1
(43) Pub. Date: Jul. 23, 2015

(54) MORTAR PACKAGES FOR MASONRY CONSTRUCTION

(71) Applicant: Preferred Inspections, Inc., Wilmington, DE (US)

(72) Inventor: Clayton L. RIDINGS, III, Wilmington, DE (US)

(21) Appl. No.: 14/549,813

(22) Filed: Nov. 21, 2014

Related U.S. Application Data
(63) Continuation-in-part of application No. 14/158,019, filed on Jan. 17, 2014, now Pat. No. 8,950,160.

(51) Int. Cl. F16L 1/028; E02D 27/42; B65D 81/32; E04H 12/34

(52) U.S. Cl. CPC F16L 1/028; E04H 12/347; E02D 27/42; B65D 81/3266

(57) ABSTRACT

Pre-filled mortar packages are positioned between masonry construction elements (such as stones, blocks or bricks) when forming a wall (such as a dry-stack stone wall). Each mortar package includes an outer covering with a porous outer surface, a mortar mixture covered by the outer covering, and (optionally) an adhesive incorporated onto or in the porous outer surface. Both the adhesive and the mortar mixture are activated by a liquid, such as water. The mortar packages may be pre-wetted before placement or may be dry when placed and then activated by applying water or by wetting from rain water. Toroidal shaped mortar packages are used as footers for posts and poles. Tubular shaped mortar packages are used as drainage ports through masonry construction or to protect buried lines.

### CROSS-REFERENCE TO RELATED APPLICATION

This application is a continuation-in-part of U.S. patent application Ser. No. 14/158,019, filed Jan. 17, 2014, now pending.

### BACKGROUND OF THE INVENTION

1. Field of the Invention

The field of the present invention is mortar packages and methods of using mortar packages, particularly for masonry construction.

2. Background

Masonry elements, such as stone walls, serve many practical purposes and can add value to a property. For example, when stones or bricks are used to form a retaining wall, a property owner can change the landscape of a sloping yard into one that is more functional. Walls can serve as demarcation lines that define the boundaries of a property. In addition, walls may improve aesthetics or visual interest of a property.

Dry stacking is one method of building a stone wall. A dry-stacked retaining wall is built by vertically stacking stones of various width, length, and thickness. As the stones are stacked, crevices between the stones are filled with sand, gravel, and smaller stones. Gravity and friction hold the stones together, usually without any type of mortar or adhesive or additional reinforcement. Stacking stones is labor intensive. As a wall is built, smaller rocks typically are broken off from larger stones and shaped to fit in gaps in the wall for leveling purposes.

Over time, however, the stones used to build dry-stacked walls shift from their initial positions. This shifting is worsened by weather effects (e.g., rain, snow, wind) and other stressors that loosen the sand, gravel, and small stones positioned in crevices in the dry stacked wall. Although some open crevices are acceptable for water drainage purposes, these crevices will eventually enlarge and adversely affect the structural integrity of the wall.

To deter the shifting and movement of stones many professional contractors reinforce the interior of walls with mortar. Using mortar only on surfaces of stones that are placed within interior portions of the wall can preserve the exterior look of a dry-stacked stone wall. Unfortunately, applying mortar to the interior of the wall is at least a two-person or more person job. In the case of two persons or more, one person continuously mixes and prepares mortar slurry for application, while at least one other person stacks stones to form the wall and applies the mortar as it is needed.

Conventional methods of dry stacking and reinforcing masonry walls can be improved upon. Dry-stacked stone walls will at some point require reinforcement because of the shifting and movement of stones. But the methods of addressing these problems require at least two people and are labor intensive. For these reasons, among others, there is a clear need for improved masonry construction methods. The present invention fulfills this need and provides further related advantages, as described in the following summary.

Conventional methods for installing support posts or poles in the ground generally require that a post hole be dug, and that a bottom portion of the post hole be filled with concrete or a mixture of stone and concrete to create a footer to support the post or pole. After the post or pole is inserted into the hole, additional concrete is poured into the hole to secure the bottom portion of the post or hole. Then, the remaining open space around the post or pole is filled with dirt. The poured footer can have an uneven surface and there is not an exact measure for the amount of concrete poured around the post or pole within the hole. Improvements to installing support posts or poles continue to be sought.

Electric lines and water lines often are buried in the ground with no encasement or plastic encasement. Improvements to protect these buried lines from puncture continue to be sought.

### SUMMARY OF THE INVENTION

The present invention is directed towards mortar packages and methods of using mortar packages for masonry construction. Instead of conventionally stacking stones to form dry-stacked stone walls and reinforcing these walls with sand, gravel, small stones, and/or concrete, mortar packages are positioned between masonry construction elements. Mortar packages may be shaped or compressed when installed to better level and stabilize wall surfaces.

A mortar package includes an outer covering, having a porous outer surface. Incorporated into or on the porous outer surface is an adhesive. A mortar mixture, which is preferably dry, is held within and covered by the outer covering. Both the adhesive and the mortar mixture preferably are activated by a liquid (e.g. water), where the term “activated” is defined herein as the setting of product constituents for bonding purposes.

In one variant, the mortar package has an outer covering forming a toroid about a central axis and defining a void at said central axis. The outer covering has a porous outer surface and defines an internal volume disposed around said central axis. A mortar mixture is held within the internal volume of the outer covering, and optionally an adhesive is incorporated in or on at least a portion of the porous outer surface. The toroid shape may be donut-shaped, square-shaped, rectangular-shaped, oval-shaped, round-shaped, circular-shaped, and tube-shaped. The voids or void spaces of the toroidal mortar packages are adapted to receive structures, such as posts or poles or water lines or power lines. The toroidal mortar packages may be used when installing footers for building construction, or may be used to form drainage ports or passageways in masonry construction.

A more complete understanding of various configurations of the mortar packages and single-person methods of using mortar packages will be afforded to those skilled in the art, as well as a realization of additional advantages and objects thereof, by consideration of the following detailed description. Reference will be made to the appended sheets which will first be described briefly.

### BRIEF DESCRIPTION OF THE DRAWINGS

The drawings described herein are for illustrative purposes only and not intended to limit the scope of the present disclosure. Like element numerals may be used to indicate like elements appearing in one or more of the figures.

FIG. 1 shows one configuration of mortar package;

FIG. 2 shows a cross-sectional view of the mortar package shown in FIG. 1 taken along line 2-2 of FIG. 1;

FIG. 3 shows a one type of stacked stone wall, including mortar packages disclosed herein;

FIG. 4 shows a cross-sectional view of the stone wall shown in FIG. 3 taken along line 4-4 of FIG. 3;

FIG. 5 shows another type of stacked stone wall, including the mortar packages disclosed herein;

FIG. 6 shows a cross-sectional view of the stone wall shown in FIG. 5 taken along line 6-6 of FIG. 5;

FIG. 6A shows a cross-sectional view of the stone wall shown in FIG. 5 taken along line 6A-6A of FIG. 5;

FIG. 7 shows a person holding an exemplary mortar package, and a bucket container filled with an activation liquid and having mortar packages of various sizes and shapes soaking in such activation liquid;

FIG. 8 outlines steps in a single-person method of using mortar packages for masonry construction;

FIG. 9 shows a perspective view of an alternative configuration of mortar package;

FIG. 10 shows a perspective view of another alternative configuration of mortar package;

FIG. 11 shows a perspective view of a post installation with a mortar package of FIG. 9 used as a footer;

FIG. 12 shows a perspective view of a post installation with a plurality of mortar packages of FIG. 9 used as footers;

FIG. 13 shows a perspective view of a pole installation with a mortar package of FIG. 10 used as a footer; and

FIG. 14 shows a perspective view of still another configuration of mortar package.

### DETAILED DESCRIPTION

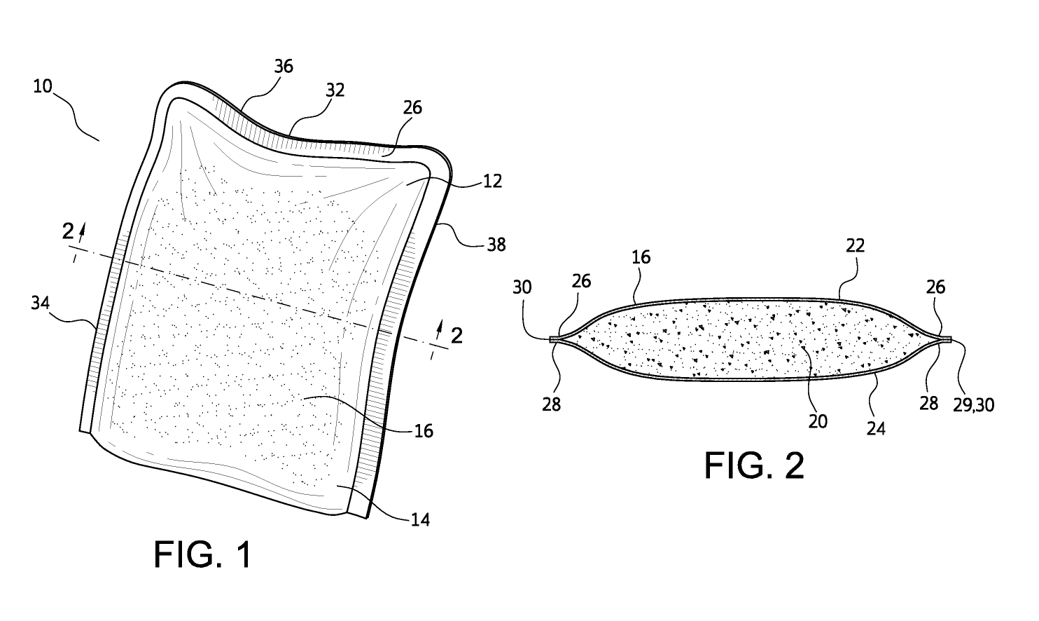

Turning in detail to the drawings, FIG. 1 shows one configuration of a mortar package 10, which is generally pillow-shaped. These types of mortar packages are particularly useful for masonry construction. The term “masonry,” however, should be broadly construed to relate to the building of structures from individual units, such as stones, blocks, and bricks, which are laid in one or more substantially linear formations. A mortar package includes an outer covering 12, having a porous outer surface 14 and an adhesive 16 incorporated into at least a portion of the porous outer surface. The outer covering 12 covers a mortar mixture 20, as shown in FIG. 2.

The outer covering 12 may have various configurations. For example, as shown in FIG. 2, the outer covering 12 can include an upper sheet 22 and a lower sheet 24. Both sheets have edges 26, 28 that may be joined together in various manners, such as bonded or seamed with an edge sealant 29 or attachment element 30 around a covering perimeter 32. The covering perimeter 32 extends along at least three sides 34, 36, 38 of the mortar package 10. Alternatively, the outer covering may be a continuous sheet of material, such that the covering forms a pouch or envelope, having an opening, which may be joined or sealed after a mortar mixture is inserted into or dispensed within the covering.

Each type of outer covering configuration includes a porous outer surface 14, optionally having an adhesive 16 incorporated therein or applied thereon. The outer covering may, for example, be manufactured from one or more woven fiber-based fabrics. Preferably, the material is biodegradable, such that it disintegrates over time without negative environmental consequences.

Burlap is one type of fiber-based fabric material that may be used for the outer covering. It is eco-friendly, porous and biodegradable. The adhesive 16 may be incorporated in or on the outer surface. The porous outer surface 14 has sufficient porosity such that a wetting or activation liquid, such as water, may penetrate through the outer surface and into the interior of the mortar package.

The adhesive 16, which optionally is incorporated into the outer surface 14, is liquid-activated (preferably water-activated) and capable of bonding to stone, block and brick materials. The adhesive provides an additional way to reinforce a masonry structure, beyond the use of adhesives and mortar mixtures used alone. Adhesive types include, but are not limited to adhesives that are resin-based and water-based or water-soluble. Representative adhesives include moisture curing adhesives such as cyanoacrylates, urethanes, rubber cements, glues or polyvinyl acetate dispersions, and pressure sensitive adhesives such as acrylate based polymers. Bioadhesives also may be used. One suitable adhesive is High Tack Fish Glue (CAS# 9000-70-8) from Norland Products, Inc. of Cranbury, N.J.

A mortar mixture 20 is held or disposed within the inner volume defined by the outer covering 12, and is covered by the outer covering 12, as particularly shown in FIGS. 2, 4, and 6. The mortar mixture 20 may be any type of mixture suitably used for building and bonding masonry structures. Such mortar mixtures traditionally include cement (e.g., Portland cement), lime, and an aggregate, such as sand. The mixtures are preferably dry, pre-mixed, powdered mixtures, which are activated by liquid, usually water. The mortar mixture 20 has a density and powder particle size range that allows the package 10 to be pliable, such that it can fit between masonry construction elements 40 of various sizes and shapes. Mortar mixes can be characterized by strength as follows: Type N is a medium strength mortar most often used for non-loadbearing brick walls and soft stone masonry; Type S is a higher strength mortar known for its ability to absorb most impacts, and can be used for patios, foundations and retaining walls; and Type M is a high strength mortar most often used with retaining walls and stone structures because it can bear heavier loads. Any of these mortar mixes is appropriately used with the present invention.

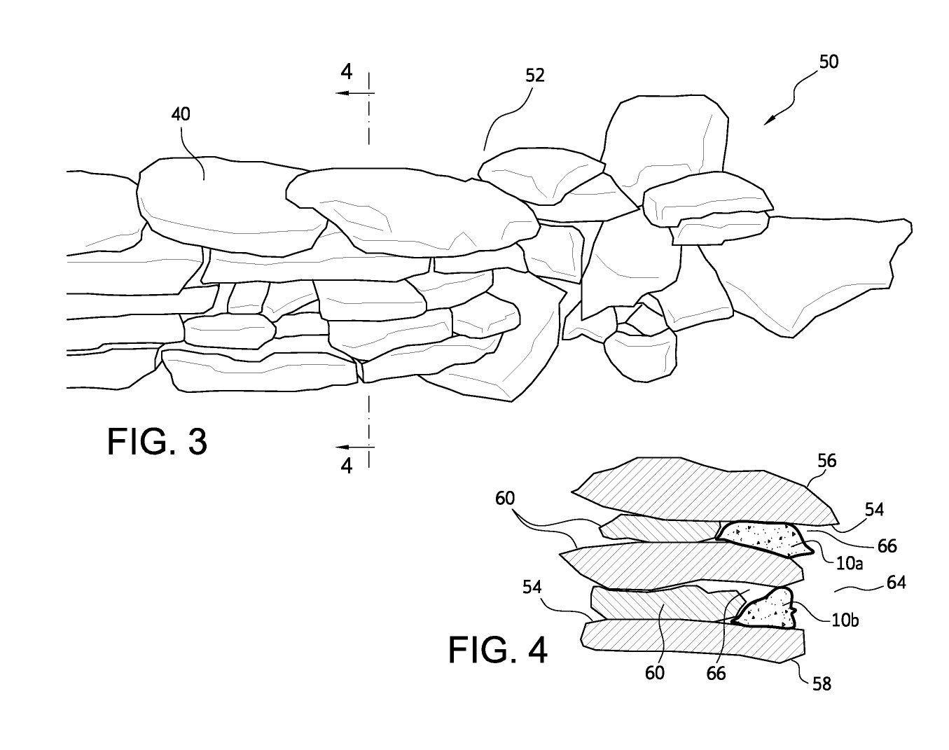

FIGS. 3 and 4 show one type of stone wall 50, which includes masonry construction elements 40 of various sizes and shapes, and mortar packages 10a, 10b installed at locations between some of the masonry construction elements 40. This type of wall includes a plurality of stones 52 with some stones having at least one substantially flat surface 54. These types of stones are typically used for dry-stacking walls.

The cross-sectional view of the wall shown in FIG. 4 includes a cap stone 56 positioned on the top of the wall, a set stone 58 positioned on the bottom of the wall, and intermediate stones 60 positioned between the cap stone 56 and the set stone 58. Mortar packages 10a, 10b are positioned in crevices or openings 66 between adjacent stones in the wall to provide reinforcement at an interior section 64 of the wall. The mortar packages 10a, 10b are used to reinforce and level the wall 50.

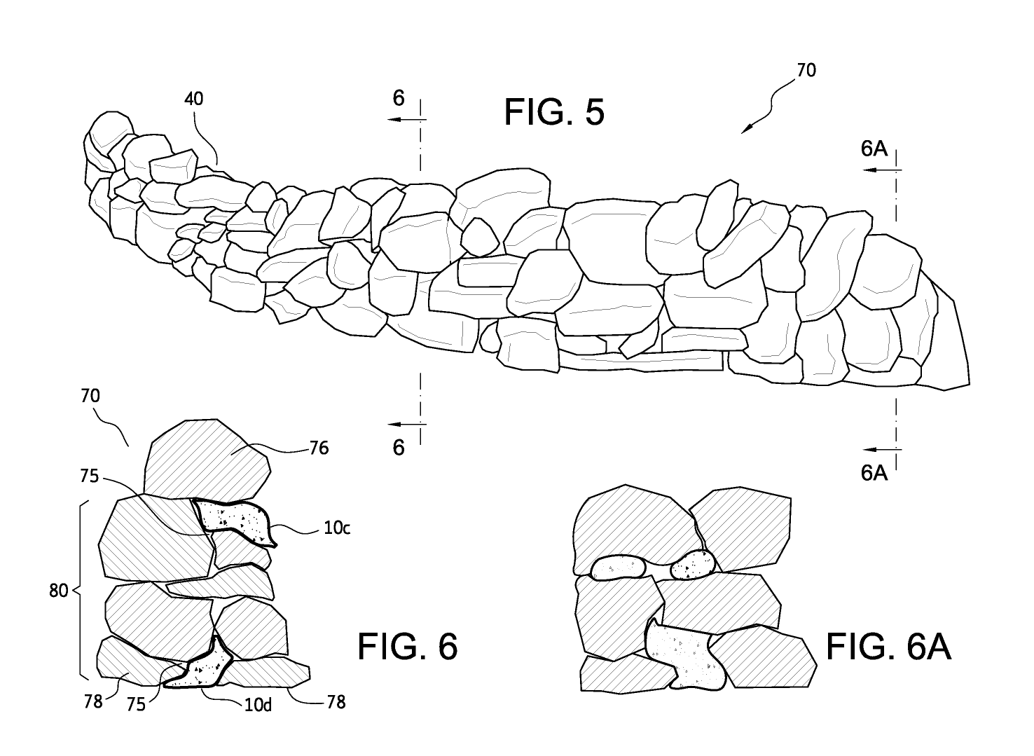

FIGS. 5 and 6 and 6A show another type of stone wall 70, which includes masonry construction elements 40 of various sizes and shapes and mortar packages 10c, 10d. This type of wall includes a plurality of stones 72 with stones having irregularly shaped surfaces 74. These types of stones are typically not used for dry-stacking. Due to the compliant nature of the mortar packages 10c, 10d, a wall which is structurally sound may be built by stacking the stones and positioning the mortar packages between some of the stones.

The cross-sectional view of the wall shown in FIG. 6 includes a cap stone 76 positioned on the top of the wall, set stones 78 positioned on the bottom of the wall, and intermediate stones 80 positioned between the cap stone 76 and set stones 78. Mortar packages 10c, 10d are positioned in crevices or openings 75 between adjacent stones in the wall 70 to provide reinforcement at an interior section 75 of the wall. The mortar packages 10c, 10d are used to reinforce and provide structural integrity to the wall 70. FIG. 6A shows another cross-sectional view of the wall of FIG. 5.

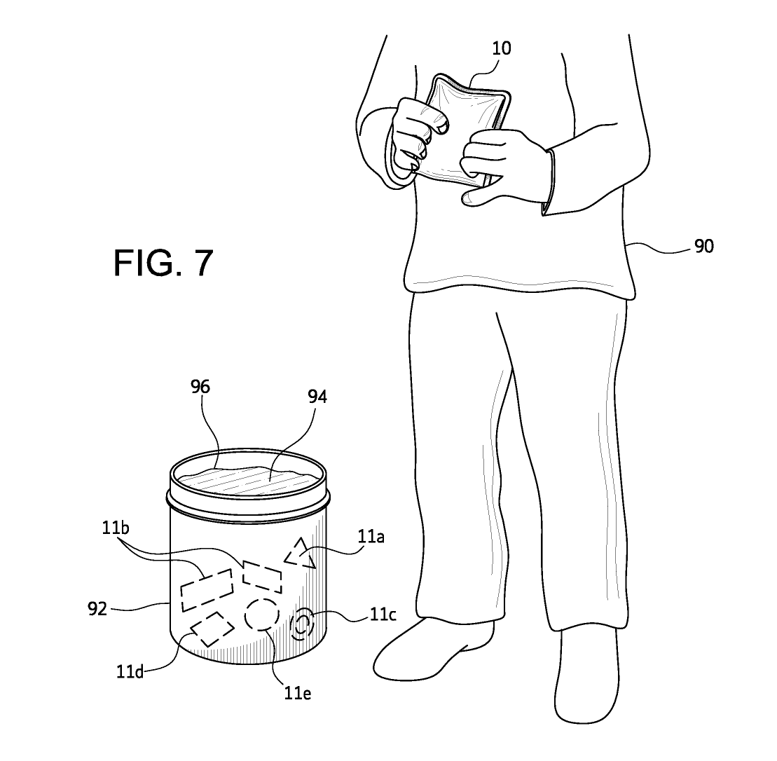

FIG. 7 shows mortar packages 11a, 11b, 11c, 11d, 11e of various shapes and sizes. The alternative shaped and sized mortar packages allow a user 90 to hand select different types of mortar packages to position in wall crevices or openings while constructing the wall. Shapes of mortar packages include, but are not limited to tubular-shaped mortar packages, triangular-shaped mortar packages 11a, oblong or rectangular-shaped mortar packages 11b, donut-shaped mortar packages 11c, rectangular or square-shaped mortar packages 11d, and oval, round or circular-shaped mortar packages 11e. Mortar packages may have varied length (or diameter), width and thickness as desired. One example of a mortar package is a square-shaped mortar package 11d, having a length and width of about 2 to 8 inches, and a thickness of about 1 to 4 inches, preferably about 1 to 2 inches. The mortar packages of the invention may have dimensions anywhere from 2 inch by 2 inch square, to 2 foot by 2 foot square, or up to 2 foot in diameter for round or oval shapes.

FIG. 7 also shows how both the optional adhesive 16 and the mortar mixture 20 can be activated by pre-soaking. A user 90 may activate the adhesive 16 and mortar mixture 20 by soaking mortar packages 10 in a bucket or container 92 with an activation liquid 94, such as water 96 therein. Alternatively, the activation liquid 94 may be applied to the mortar package by wetting mortar packages after they are positioned in a wall. Wetting may occur by hosing down the wall or dousing interior sections of the wall that include the mortar packages with water. As still another alternative, a user may allow a soaking rainfall to wet the wall and thereby indirectly wet the mortar packages to activate the adhesive and mortar mixture.

Together, the optional adhesive 16 and the mortar mixture 20 of the mortar packages bond masonry construction elements 40 to one another. There is advantage to the combination of adhesive 16 and mortar mixture 20 where an adhesive may be selected to more rapidly set and secure the mortar package to the masonry elements, giving time for the mortar mixture to cure. As such, mortar packages 10, 11 may be used to form walls with increased strength, compared to those which use adhesives or mortar alone. These walls are also less susceptible to weather damage and more resistant to other damage.

The mortar packages 10, 11 when installed may act as a balancer or anti-rock dampener to keep the masonry construction elements 40, particularly those with irregular surfaces such as stones, from rocking or working loose from the wall or other masonry structure.

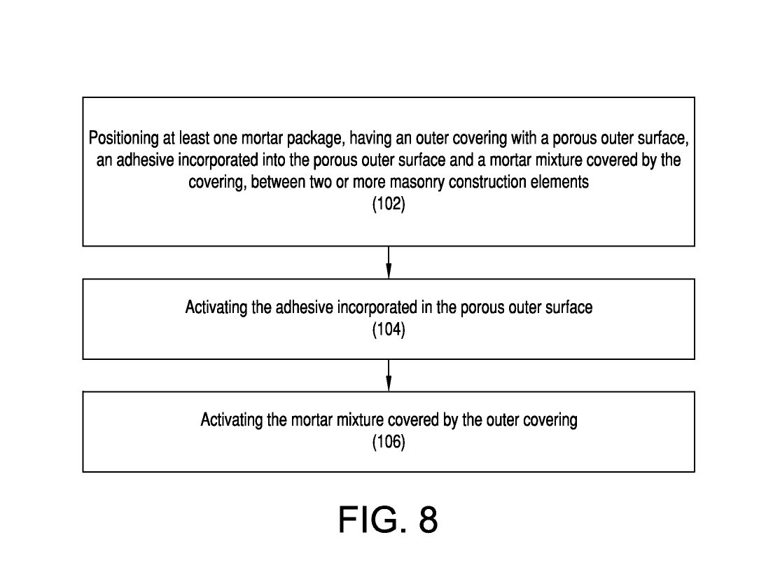

FIG. 8 shows a series of steps for a single-person method 100 of using the mortar packages, described herein, for masonry construction. These steps include:
Positioning at least one mortar package, having an outer covering with a porous outer surface, an adhesive incorporated into the porous outer surface and a mortar mixture covered by the covering, between two or more masonry construction elements 102;
Activating the adhesive incorporated in or on the porous outer surface 104; and
Activating the mortar mixture covered by the outer covering 106.

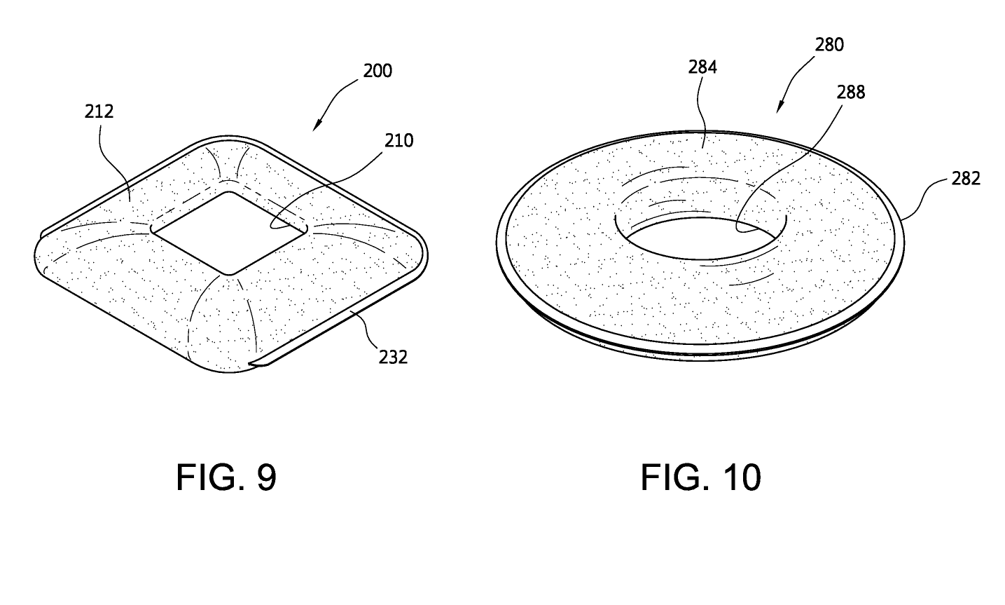

FIG. 9 shows an alternative configuration of a mortar package 200 that forms a toroid with a square-shaped void space 210 surrounded by the mortar filled covering. The outer covering 212 has a porous surface and may be coated with adhesive, as described above for mortar packages of pillow configuration. A mortar mixture 220 is held within internal volume space bounded by the outer covering 212. The covering perimeter 232 may be bonded with edge sealant or other attachment element, such as but not limited to sewing, to hold the mortar mixture 220 in the mortar package 200.

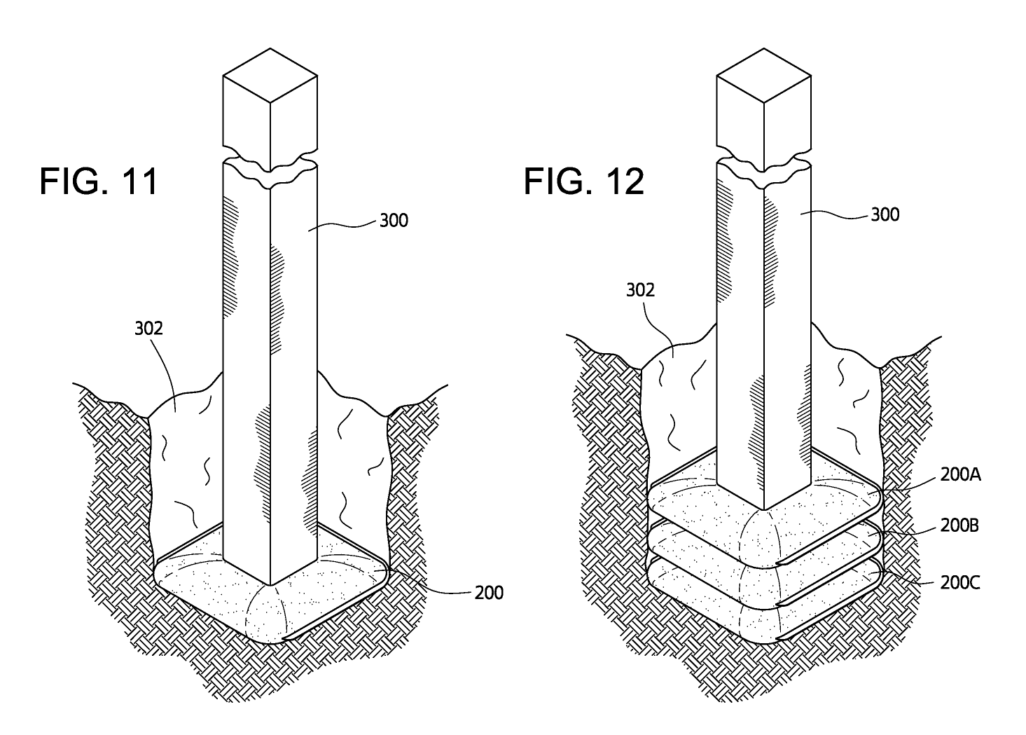

Referring now to FIG. 11, one mortar package 200 may be installed within a hole 302 to form a support or footer for a post 300. The mortar package 200 may be pre-wet or soaked in water before inserting the mortar package 200 into the hole 302. Then, the post 300 may be inserted into the hole 302 and into the void 210 in the mortar package 200. As yet another alternative, the mortar package 200 may be inserted into the hole 302, and the post 300 may be inserted into the hole and the void 210 before the mortar package 200 has been wetted to activate the adhesive and mortar. In this alternative method, once the mortar package 200 and post 300 are installed in the hole 302, water may be poured into the hole around the post 300 to activate the adhesive and the mortar. After the mortar is set (e.g., dried), the hole may then be refilled with dirt. The resulting support structure resists frost heave and is more uniformly supporting the post 300 in the hole 302.

FIG. 12 shows another option for mounting a post 300 into the ground. Here, multiple mortar packages 200A, 200B and 200C are set into the hole 302 in stacked relation with their void spaces 210 aligned. The post 300 then may be inserted into the hole 302 and into the voids 210 in the mortar packages 200A, 200B and 200C. In one method, the mortar packages 200A, 200B and 200C are pre-wet or soaked in water before they are installed into the hole 302. In an alternative method, the mortar packages 200A, 200B and 200C are installed into the hole 302, and the post 300 is inserted into the hole and into the voids 210 in the mortar packages 200A, 200B and 200C first. Then, water is poured into the hole 302 around the post 300 to active the adhesive and the mortar. The embodiment shown in FIG. 12 has advantage of enhanced stability and resistance to frost heave.

In one variation of this method, once the hole 302 is dug, first, at least one mortar package 10 is placed in the hole. This form of mortar package 10 is not a toroid and lacks a void space. Then, one or more mortar packages 200 may be installed or set in stacked relation over the first mortar package 10. Then, the post 300 is inserted into the hole 302 and into the voids or void spaces 210 in the mortar package(s) 200.

Referring now to FIG. 10, a mortar package 280 may be formed in a donut-shape or a toroid with a round annular shape surrounding a void space 288. The mortar package 280 also has a porous outer covering 284 that optionally may be coated with adhesive. A mortar mixture is held within the volume space defined by the covering 284. The outer covering perimeter 282 may be bonded with edge sealant or other attachment element, such as but not limited to sewing, to hold the mortar mixture in the mortar package 280.

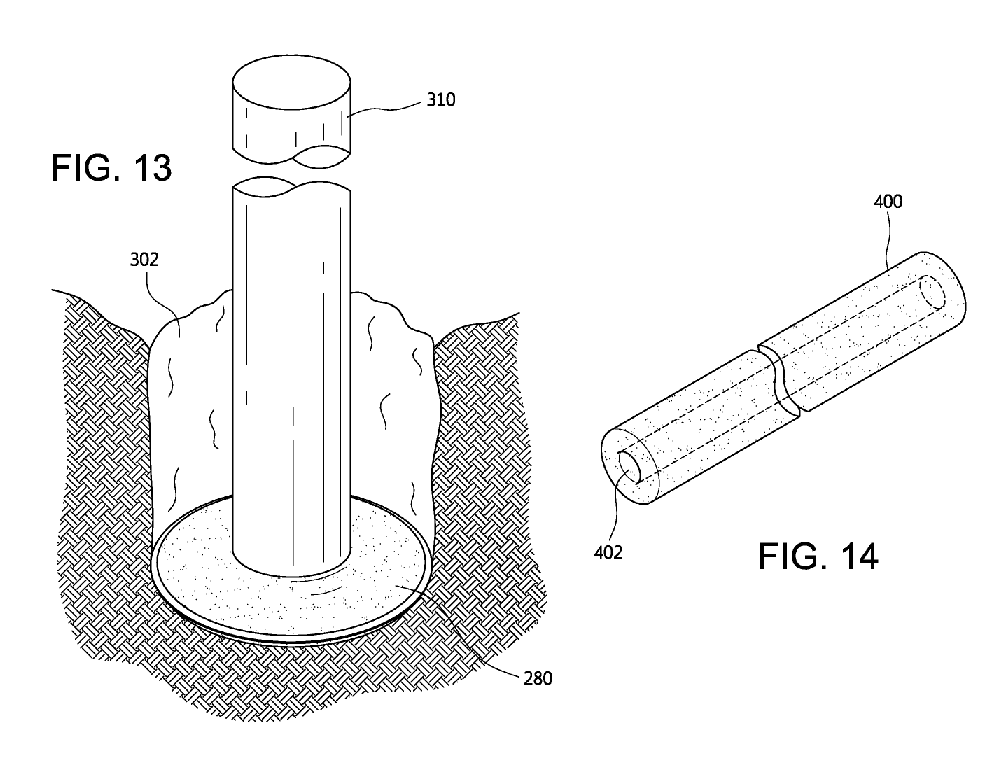

FIG. 13 shows one mortar package 280 may be installed within a hole 302 to form a support or footer for a pole 310. The mortar package 280 may be pre-wet or soaked in water before inserting the mortar package 280 into the hole 302. Then, the pole 310 may be inserted into the hole 302 and into the void 288 in the mortar package 280. As yet another alternative, the mortar package 280 may be inserted into the hole 302, and the pole 310 may be inserted into the hole and the void 288 before the mortar package 280 has been wetted to activate the adhesive and mortar. In this alternative method, once the mortar package 280 and pole 310 are installed in the hole 302, water may be poured into the hole around the pole 310 to activate the adhesive and the mortar. After the mortar is set (e.g., dried), the hole may then be refilled with dirt. The resulting support structure resists frost heave and is more uniformly supporting the pole 310 in the hole 302. As yet another alternative, comparable to the structure shown in

FIG. 12, multiple mortar packages 280 could be inserted into a hole 302 in stacked relation with their void spaces aligned. One end of the pole 310 may be inserted into the hole 302 and into the void spaces of the stacked mortar packages 280. The stacked mortar packages could be pre-wet or soaked before their insertion into the hole 302, or could be wet after the pole 310 is installed therein.

Optionally, a footer may be formed by inserting one or more mortar packages 200, 280 into a hole 302 and activating the adhesive and mortar by wetting. Because the mortar packages 200, 280 have void spaces 210, 288, a post or pole may be inserted into the void space(s) after the adhesive and mortar have set (dried). Multiple mortar packages 200A, 200B, 200C could be stacked, activated and set to form a footer in one hole before installing a post or pole.

FIG. 14 shows yet another alternative mortar package 400 shaped as an elongated tube with a central channel 402. The mortar package 400 preferably has a porous surface that may be coated with an adhesive. A mortar composition is held within the inner volume of the mortar package. A water line or an electrical line or multiple lines intended for installation in ground may be threaded through the elongated tube and held in the central channel 402. The mortar package 400 then may be buried in the ground and forms a protective shield to the line(s) held therein. The mortar package 400 may be pre-wet or soaked prior to installing in the ground, or water may be poured onto the mortar package after it has been laid into a trench or hole in the ground. Once the adhesive and mortar are set, the mortar package 400 resists penetration or puncturing, and thus better shields the water line or electric line.

The mortar package 400 of FIG. 14 may be used also to form a drainage port or passageway or hole through a wall. In such embodiment, the mortar package 400 is installed between stones or between other masonry construction elements as a wall is formed. The adhesive and mortar may be activated by pre-wetting or soaking the mortar package 400 prior to placing it between masonry construction elements.

While embodiments of this invention have been shown and described, it will be apparent to those skilled in the art that many more modifications are possible without departing from the inventive concepts herein. The invention, therefore, is not to be restricted except in the spirit of the following claims.

1. A mortar package, comprising:
an outer covering forming a toroid about a central axis and defining a void at said central axis, said outer covering having a porous outer surface and defining an internal volume disposed around said central axis;
a mortar mixture held within the internal volume of the outer covering; and
an adhesive incorporated in or on at least a portion of the porous outer surface.

2. The mortar package of claim 1, wherein the outer covering comprises at least one sheet of fibrous material.

3. The mortar package of claim 1, wherein the outer covering comprises an upper sheet and a lower sheet.

4. The mortar package of claim 3, wherein the upper sheet and the lower sheet are joined together along a covering perimeter.

5. The mortar package of claim 1, wherein the outer covering comprises a biodegradable material.

6. The mortar package of claim 1, wherein the adhesive is water-activated.

7. The mortar package of claim 1, wherein the mortar mixture is concrete or concrete based.

8. The mortar package of claim 1, wherein the toroid is a shape selected from the group consisting of: donut-shaped, square-shaped, rectangular-shaped, oval-shaped, round-shaped, circular-shaped, and tube-shaped.

9. A method for installing a post or pole in ground, comprising:
forming a hole;
placing at least one mortar package in said hole, said mortar package comprising an outer covering forming a toroid about a central axis and defining a void at said central axis, said outer covering having a porous outer surface and defining an internal volume disposed around said central axis, a mortar mixture held within the internal volume of the outer covering, and an adhesive incorporated in or on at least a portion of the porous outer surface; and
inserting one end of the post or pole into the void of the at least one mortar package.

10. The method of claim 9, further comprising pre-wetting the at least one mortar package before placing the at least one mortar package in said hole.

11. The method of claim 9, further comprising placing multiple mortar packages in stacked relation one on top of the other in said hole.

12. The method of claim 9, further comprising pouring water into said hole to wet the at least one mortar package.

13. The method of claim 9, wherein the toroid is a shape selected from the group consisting of: donut-shaped, square-shaped, rectangular-shaped, oval-shaped, round-shaped, circular-shaped, and tube-shaped.

14. The method of claim 9, further comprising first placing at least one first mortar package in said hole, wherein said at least one first mortar package has a face surface without a defined void forming a toroid, wherein said at least one mortar package that does define a void then is placed over the at least one first mortar package.

15. A method for installing a water or electric line in ground, comprising:
forming a trench or hole;
threading the line through a mortar package, said mortar package comprising an outer covering forming a toroid about a central axis and defining a void at said central axis, said outer covering having a porous outer surface and defining an internal volume disposed around said central axis, a mortar mixture within the internal volume of the outer covering, and an adhesive incorporated in or on at least a portion of the porous outer surface; and
inserting the mortar package with line threaded therein into the trench or hole.

16. The method of claim 15, further comprising pouring water into said hole to wet the mortar package.

17. The method of claim 15, further comprising covering exposed surface(s) of the mortar package with dirt.

18. The method of claim 15, wherein the toroid is a shape selected from the group consisting of: donut-shaped, square-shaped, rectangular-shaped, oval-shaped, round-shaped, circular-shaped, and tube-shaped.
